(19) United States
(12) Patent Application Publication
(10) Pub. No.: US 2008/0116942 A1
(43) Pub. Date: May 22, 2008

(54) Drive voltage generator

(75) Inventor: Chi-Chang Chen, Taoyuan County (TW)

Correspondence Address: BIRCH STEWART KOLASCH & BIRCH, PO BOX 747, FALLS CHURCH, VA, 22040-0747, US

(73) Assignee: Princeton Technology Corporation

(21) Appl. No.: 11/790,440

(22) Filed: Apr. 25, 2007

(30) Foreign Application Priority Data
Nov. 20, 2006 (TW) 095142794

(51) Int. Cl. H02M 11/00

(52) U.S. Cl. 327/103

(57) ABSTRACT

The invention discloses drive voltage generators. A drive voltage generator comprises a voltage source, a variable current source, and a unity-gain buffer amplifier. The resistor is coupled between the voltage source and the output terminal of the variable current source. The output terminal of the variable current source is coupled to the input terminal of the unity-gain buffer amplifier, and the output terminal of the unity-gain buffer amplifier acts as the output terminal of the drive voltage current source, and has a voltage level varying with the variable current source. In some embodiments, the variable current source is realized by current mirror techniques.

### BACKGROUND OF THE INVENTION

1. Field of the Invention

The invention relates to circuits for generating drive voltage, and particular to drive voltage generators for image displays.

2. Description of the Related Art

FIG. 1 shows a conventional drive voltage generator 100, comprising a plurality of resistors R coupled in series between a voltage source V_{DD} and a ground terminal V_{SS}, a plurality of transmission gates T₁, T₂, T₃, T₄, T₅, T₆, and T₇, and a unity-gain buffer amplifier 102. The conventional drive voltage generator 100 further comprises a control circuit (not shown) generating a plurality of control signals C₁, C₂, C₃, C₄, C₅, C₆, and C₇ controlling the transmission gates T₁, T₂, T₃, T₄, T₅, T₆, and T₇, respectively. The voltage level of terminal 104 varies with the status (on or off) of the transmission gates T₁, T₂, T₃, T₄, T₅, T₆, and T₇. To generate a drive voltage without varying with the load current, the terminal 104 is coupled to the input terminal of the unit-gain buffer amplifier 102, and the drive voltage is generated at the output terminal of the unit-gain buffer amplifier 102 (Vₒᵤₜ). Obviously, the status of the transmission gates T₁, T₂, T₃, T₄, T₅, T₆, and T₇ controls the voltage level of the drive voltage (Vₒᵤₜ), too.

As shown in FIG. 1, the voltage level of the drive voltage (Vₒᵤₜ) is determined by a voltage divider comprising the serially coupled resistors R. In the case shown in FIG. 1, to provide seven voltage levels for the terminal 104, seven transmission gates (T₁, T₂, T₃, T₄, T₅, T₆, and T₇) and at least eight resistors R are required, and the control circuit must generate seven control signals (C₁, C₂, C₃, C₄, C₅, C₆, and C₇) controlling the on/off status of the seven transmission gates (T₁, T₂, T₃, T₄, T₅, T₆, and T₇), respectively. The number of transmission gates and control signals required in the conventional drive voltage generator 100 is considerable. To reduce the number of transmission gates and control signals, novel drive voltage generators are called for.

### BRIEF SUMMARY OF THE INVENTION

The invention provides drive voltage generators comprising a voltage source, a variable current source, a resistor, and a unit-gain buffer amplifier. The resistor is coupled between the voltage source and an output terminal of the variable current source. The input terminal of the unity-gain buffer amplifier is coupled to the output terminal of the variable current source. The output terminal of the unity-gain buffer amplifier acts as the output terminal of the drive voltage generator, voltage level of which is controlled by the output current generated by the variable current source.

In some embodiments, the variable current source is realized by current mirror techniques. The variable current source comprises a reference current source, a first transistor, a plurality of second transistors, a plurality of transmission gates respectively coupled to the second transistors, and a control circuit. The first transistor has a gate and a drain coupled together. The output terminal of the reference current source is coupled to the drain of the first transistor. The voltage difference between a gate and a source of each second transistor is the same as that of the first transistor, and the drains of the second transistors are coupled together and act as the output terminal of the variable current source. The gates of the second transistors are respectively coupled to the gate of the first transistor via the transmission gates. The on/off status of the transmissions gates are controlled by the control circuit, and thus the output current of the variable current source is controlled by the control circuit. In some cases, the second transistors have distinct channel width to length ratios (W/L).

The variable current source further comprises a third transistor. The second transistors are coupled to the output terminal of the variable current source via the third transistor, and the channel length modulation effects of the second transistors are eliminated by the third transistor. The third transistor has a source coupled to the drains of the second transistor, a drain acting as the output terminal of the variable current source, and a gate biased by a bias voltage.

In some cases, the drive voltage generators of the invention can be utilized to drive liquid crystal displays to adjust the image contrast of the liquid crystal displays.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional drive voltage generator;

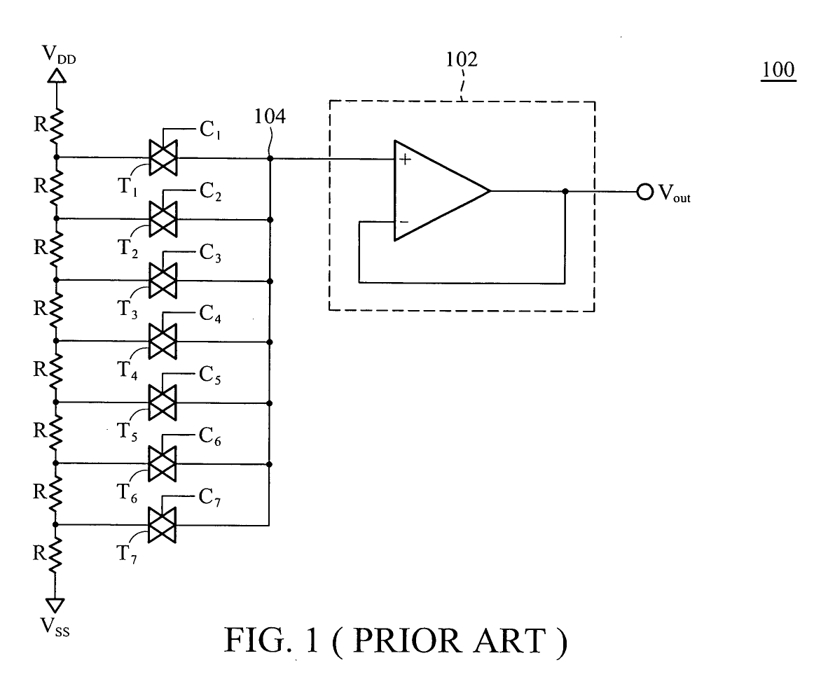

FIG. 2 shows an embodiment of the invention;

FIG. 3 shows another embodiment of the invention, wherein the variable current source is realized by current mirror techniques; and

FIG. 4 shows another embodiment of the invention, wherein the channel length modulation effect caused by the second transistors is eliminated.

### DETAILED DESCRIPTION OF THE INVENTION

The following description is made for the purpose of illustrating the general principles of the invention and should not be taken in a limiting sense. The scope of the invention is best determined by reference to the appended claims.

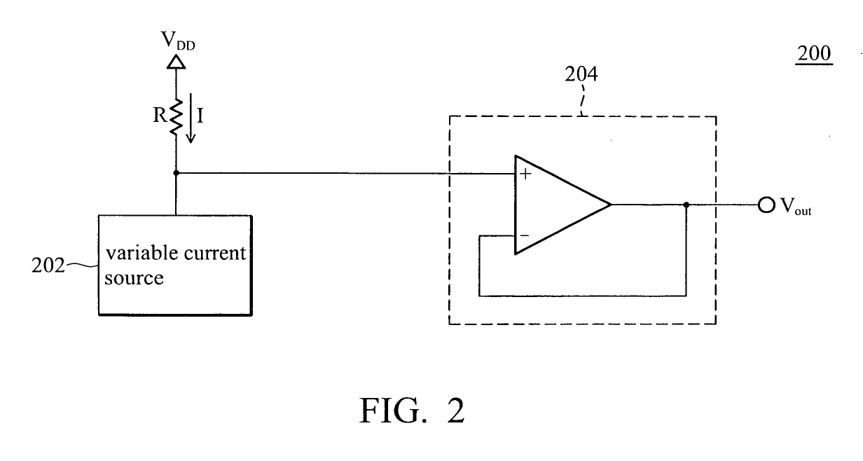

FIG. 2 shows an embodiment of the invention. The drive voltage generator 200 comprises a voltage source V_{DD}, a variable current source 202, a resistor R, and a unity-gain buffer amplifier 204. The resistor R is coupled between the voltage source V_{DD} and an output terminal of the variable current source 202. The output terminal of the variable current source 202 is coupled to an input terminal of the unity-gain buffer amplifier 204, and the output terminal of the unity-gain buffer amplifier 204 acts as the output terminal (Vₒᵤₜ) of the drive voltage generator 200. As shown in FIG. 2, the voltage level of the drive voltage (Vₒᵤₜ) varies with the voltage level of the output terminal of the variable current source 202. Since the voltage level of the output terminal of the variable current source 202 is (V_{DD}−I·R), the voltage level of the drive voltage (Vₒᵤₜ) is (V_{DD}−I·R).

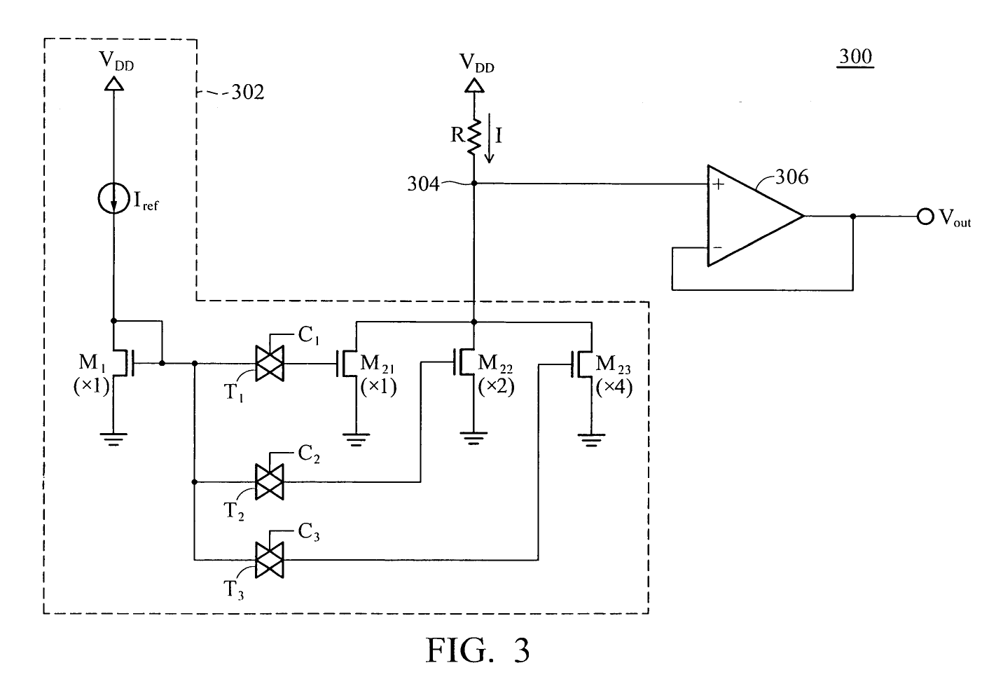

In some embodiments, the variable current source 202 is realized by current mirror techniques. FIG. 3 shows another embodiment of the invention, wherein variable current source 302 of the drive voltage generator 300 comprises a reference current source I_{ref}, a first transistor M₁, a plurality of second transistors M₂₁, M₂₂, and M₂₃, a plurality of transmission gates T₁, T₂, and T₃ respectively coupled to the second transistors M₂₁, M₂₂, and M₂₃, and a control circuit (not shown). The gate and drain of the first transistor M₁ are coupled together. The output terminal of the reference current source I_{ref} is coupled to the drain of the first transistor M₁. The voltage difference between the gate and source of each second transistor M₂₁, M₂₂, and M₂₃ is similar to that of the first transistor M₁. The drain of the second transistors M₂₁, M₂₂, and M₂₃ are coupled together at node 304 to act as the output terminal of the variable current source 302. The transmissions gates T₁, T₂, and T₃ couple the gates of the second transistors M₂₁, M₂₂, and M₂₃ to the gate of the first transistor M1, respectively. The on/off status of the transmission gates T₁, T₂, and T₃ are controlled by control signals C₁, C₂, and C₃ generated by the control circuit. The status (on/off) of the transmission gates T₁, T₂, and T₃ determines the value of the output current I of the variable current source 302, and the voltage value of the drive voltage (Vₒᵤₜ) is determined by the value of the current I.

In some embodiments, the second transistors M₂₁, M₂₂, and M₂₃ may have distinct channel width to length ratios (W/L). In one case, the first transistor M₁ and the second transistors M₂₁, M₂₂, and M₂₃ are manufactured by similar process, and the channel width to length ratios (W/L) thereof are in a ratio of 1:1:2:4. Table 1 shows the relationship between the output current I of the variable current source 302 and the control signals C₁, C₂, and C₃, and voltage value of the drive voltage Vₒᵤₜ generated in different control signals. The transmission gate is turned off when the corresponding control signal is ‘0’, and turned on when the corresponding control signal is ‘1’.

TABLE 1

| C₃ | C₂ | C₁ | I | Vₒᵤₜ |
|---|---|---|---|---|
| 0 | 0 | 1 | I_{ref} | V_{DD} − I_{ref} · R |
| 0 | 1 | 0 | 2 · I_{ref} | V_{DD} − 2 · I_{ref} · R |
| 0 | 1 | 1 | 3 · I_{ref} | V_{DD} − 3 · I_{ref} · R |
| 1 | 0 | 0 | 4 · I_{ref} | V_{DD} − 4 · I_{ref} · R |
| 1 | 0 | 1 | 5 · I_{ref} | V_{DD} − 5 · I_{ref} · R |
| 1 | 1 | 0 | 6 · I_{ref} | V_{DD} − 6 · I_{ref} · R |
| 1 | 1 | 1 | 7 · I_{ref} | V_{DD} − 7 · I_{ref} · R |

As shown, the drive voltage generator 300 provides seven options for the drive voltage Vₒᵤₜ. Compared with the conventional drive voltage generator 100, only three transmission gates T₁, T₂, and T₃ are required in the drive voltage generator 300, fewer than those (T₁˜T₇) required in the conventional drive voltage generator 100. The number of control signals is reduced from seven (C₁˜C₇) to three (C₁, C₂, and C₃) correspondingly

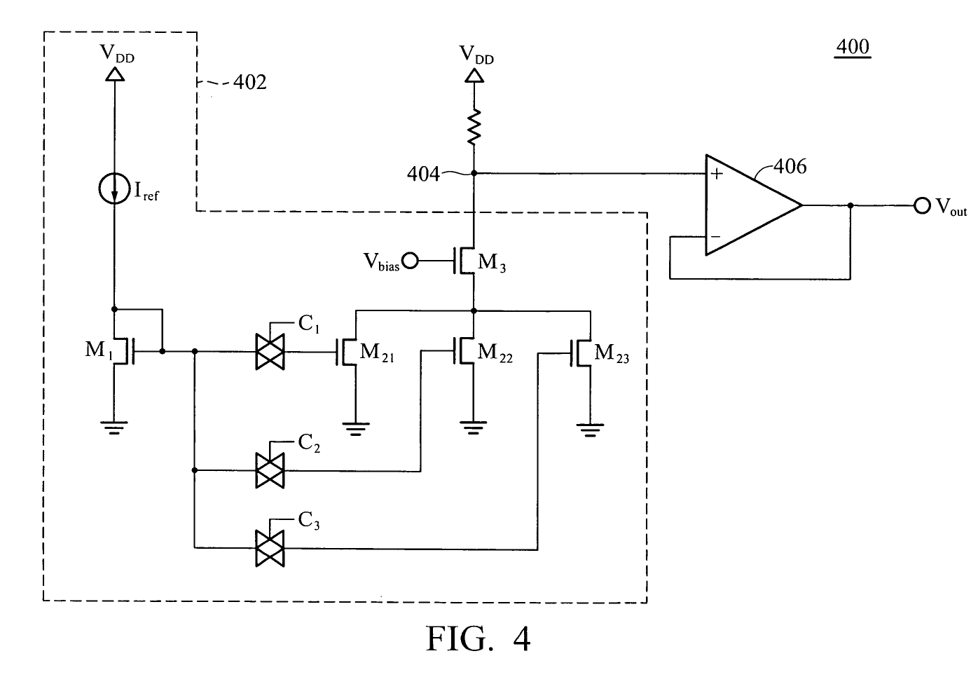

FIG. 4 shows another embodiment of the invention. Compared with FIG. 3, the variable current source 402 of the drive voltage generator 400 further comprises a third transistor M₃ eliminating the channel length modulation effects caused by the second transistors M₂₁, M₂₂, and M₂₃. The third transistor M₃ has a source coupled to the drains of the second transistors M₂₁, M₂₂, and M₂₃, a drain coupled to node 404 to act as the output terminal of the variable current generator 402, and a gate biased by a bias voltage.

In some embodiments, the drive voltage generators of the invention are realized in liquid crystal displays to control the image contrast. For example, a liquid crystal display with the drive voltage generator 300 can provide seven image contrasts since the drive voltage generator 300 can provide a drive voltage of seven different voltage levels.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A drive voltage generator, comprising:
a voltage source;
a variable current source;
a resistor, coupled between the voltage source and an output terminal of the variable current source; and
an unity gain buffer amplifier, having an input terminal coupled to the output terminal of the variable current source;
wherein the output terminal of the unity gain buffer amplifier acts as an output terminal of the drive voltage generator, and the voltage level of the output terminal of the unity gain buffer amplifier varies with the variable current source.

2. The drive voltage generator as claimed in claim 1, wherein the variable current source utilizes current mirror techniques.

3. The drive voltage generator as claimed in claim 2, wherein the variable current source comprises:
a reference current source;
a first transistor, having a gate and a source coupled together, and having a drain coupled to an output terminal of the reference current source;
a plurality of second transistors, each having a drain coupled to the input terminal of the unity-gain buffer amplifier;
a plurality of transmission gates, respectively coupling gates of the second transistors to the gate of the first transistor; and
a control circuit, controlling the on/off status of the transmission gates to control an output current generated by the variable current source.

4. The drive voltage generator as claimed in claim 3, wherein the variable current source further comprises a third transistor eliminating the channel length modulation effects caused by the second transistors, the third transistor having a source coupled to the drains of the second transistors, having a drain coupled to the input terminal of the unity-gain buffer amplifier, and having a gate coupled to a bias voltage.

5. The drive voltage generator as claimed in claim 3, wherein the second transistors are of distinct channel width to length ratios.

6. The drive voltage generator as claimed in claim 3 implemented in a liquid crystal display for controlling image contrast.

7. The drive voltage generator as claimed in claim 3, wherein a voltage difference between the gate and a source of the first transistor is equivalent to those of the second transistors.
